(19) United States
(12) Patent Application Publication
(10) Pub. No.: US 2017/0232552 A1
(43) Pub. Date: Aug. 17, 2017

(54) RECLAMATION SYSTEM FOR REACTIVE METAL POWDER FOR ADDITIVE MANUFACTURING SYSTEM

(71) Applicant: General Electric Company, Schenectady, NY (US)

(72) Inventors: Donnell Eugene Crear, Simpsonville, SC (US); Archie Lee Swanner, JR., Easley, SC (US)

(21) Appl. No.: 15/042,286

(22) Filed: Feb. 12, 2016

(51) Int. Cl. B23K 26/142; B23K 26/70; B23K 26/342; B33Y 30/00; B33Y 40/00

(52) U.S. Cl. CPC B23K 26/142; B33Y 30/00; B33Y 40/00; B23K 26/342; B23K 26/703

(57) ABSTRACT

A reclamation system for a metal powder, such as a reactive metal powder, is disclosed. The system may include a container; and a pressure source in fluid communication with the container for creating a selected pressure within the container, the container including: an inlet to a lower portion of the tank that is configured to hold a liquid, and an outlet. A controller controls the pressure source to control the pressure applied within the container between: a vacuum state creating a flow of air entrained metal powder to enter the inlet for forming a reclaimed metal powder by removing the metal powder from the air by immersion in the liquid, and an evaporation state that causes evaporation of the liquid to a gas that exits through the outlet. A condenser condenses the gas to a condensed liquid.

### BACKGROUND OF THE INVENTION

The disclosure relates generally to additive manufacturing, and more particularly, to a reclamation system for a metal powder for an additive manufacturing system, and is especially advantageous as applied to a reactive metal powder.

Additive manufacturing (AM) includes a wide variety of processes of producing an object through the successive layering of material rather than the removal of material. As such, additive manufacturing can create complex geometries without the use of any sort of tools, molds or fixtures, and with little or no waste material. Instead of machining components from solid billets of material, much of which is cut away and discarded, the only material used in additive manufacturing is what is required to shape the object.

Additive manufacturing techniques typically include taking a three-dimensional computer aided design (CAD) file of the object to be formed, electronically slicing the object into layers, e.g., 18-102 micrometers thick, and creating a file with a two-dimensional image of each layer. The file may then be loaded into a preparation software system that interprets the file such that the object can be built by different types of additive manufacturing systems. In 3D printing, rapid prototyping (RP), and direct digital manufacturing (DDM) forms of additive manufacturing, material layers are selectively dispensed to create the object.

In metal powder additive manufacturing techniques, such as selective laser melting (SLM) and direct metal laser melting (DMLM), metal powder layers are sequentially melted together to form the object. More specifically, fine metal powder layers are sequentially melted after being uniformly distributed using an applicator on a metal powder bed. The metal powder bed can be moved in a vertical axis. The process takes place in a processing chamber having a precisely controlled atmosphere of inert gas, e.g., argon or nitrogen. Once each layer is created, each two dimensional slice of the object geometry can be fused by selectively melting the metal powder. The melting may be performed by a high powered laser such as a 100 Watt ytterbium laser to fully weld (melt) the metal powder to form a solid metal. The laser moves in the X-Y direction using scanning mirrors, and has an intensity sufficient to fully weld (melt) the metal powder to form a solid metal. The metal powder bed is lowered for each subsequent two dimensional layer, and the process repeats until the object is completely formed.

Certain metal powders used in additive manufacturing are reactive; that is, they are ignitable or combustible in a powder form in an oxygen environment such as air. Two example reactive metal powders are aluminum and titanium. The reactive metal powders pose challenges relative to additive manufacturing in terms of cleaning of additive manufacturing machines, cleaning of metal powder spills, etc. Currently, reactive metal powders are collected in a wet separator, i.e., wet vacuum, from whatever surface they are on (e.g., process chamber of AM system, on floor therearound, etc.). Conventional wet (also known as immersion) separators vacuum the reactive metal powder into a chamber in which the powder is immersed in a liquid, e.g., water or oil, to create a liquid-metal powder sludge for safer handling. Example wet or immersion separators commercially available include: Tiger-Vac SS-IT EX models available from Tiger-Vac International, Inc., Laval, Quebec, CA, or Ruwac NA, NA35 or NA250 models available from Ruwac USA, Holyoke, Mass., USA. In any wet separator, the chamber (e.g., a tank) on the wet separator fills and requires periodic emptying. Current wet separators do not separate the liquid and metal powder, which requires disposal of the sludge using costly and complicated hazardous waste disposal techniques.

### BRIEF DESCRIPTION OF THE INVENTION

A first aspect of the disclosure provides a reclamation system for a metal powder, the reclamation system comprising: a container; a pressure source in fluid communication with the container for creating a selected pressure within the container, the container including: an inlet to a lower portion of the tank that is configured to hold a liquid, and an outlet; a controller controlling the pressure source to control the pressure applied within the container between: a vacuum state in which the pressure creates a flow of air entrained metal powder to enter the inlet for forming a reclaimed metal powder by removing the metal powder from the air by immersion of the air entrained metal powder in the liquid, and an evaporation state in which the pressure within the container causes evaporation of the liquid to a gas that exits through the outlet; and a condenser in fluid communication with the outlet of the container for receiving the gas from the container and condensing the gas to a condensed liquid.

A second aspect of the disclosure provides a metal powder additive manufacturing system, comprising: a metal powder additive manufacturing printer including a processing chamber and a controller; and a reclamation system for the metal powder, the reclamation system including: a container; a pressure source in fluid communication with the container for creating a variable pressure within the container, the container including: an inlet to a lower portion of the tank that is configured to hold a liquid, and an outlet; a controller controlling the pressure source to control the variable pressure applied within the container between: a vacuum state in which a flow of air entrained metal powder enters the inlet from the processing chamber for forming a reclaimed metal powder by removing the metal powder from the air by immersion of the air entrained metal powder in the liquid, and an evaporation state in which the variable pressure within the container causes evaporation of the liquid to a gas that exits through the outlet; and a condenser in fluid communication with the outlet of the container for receiving the gas from the container and condensing the gas to a condensed liquid.

A third aspect of the disclosure provides a method of reclaiming a metal powder, the method comprising: entraining the metal powder in an air flow; immersion separating the metal powder from the air flow by passing the air flow through a liquid in a container; and reclaiming the metal powder by evaporating the liquid from the container into a gas and removing the gas from the container.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic block diagram of an additive manufacturing system including a reclamation system according to embodiments of the disclosure.

FIG. 2 shows a schematic diagram of a reclamation system according to embodiments of the disclosure.

FIG. 3 shows a schematic diagram of a container for use with a reclamation system according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

In the following specification and the claims, reference will be made to a number of terms, which shall be defined to have the following meanings:

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately” and “substantially”, are not to be limited to the precise value specified and may be, for example, +/−10% of the stated value(s). In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As indicated above, the disclosure provides a reclamation system for metal powder that can be incorporated as part of a metal powder additive manufacturing system. The reclamation system incorporates attributes of a wet or immersion separator, but, in contrast to conventional separators, also acts to separate the immersion liquid used from the metal powder to improve safe disposal of each, particularly where the metal powder includes a reactive metal powder. That is, the reclamation system allows separation of a metal powder from an immersion liquid that includes water, and disposal of the materials in phases rather than together as a sludge.

As used herein, “reactive metal powder” may include any metal powder that poses a reaction risk like combust-ability or ignitability in an oxygen containing atmosphere (e.g. air) in powder form, most notably: aluminum and titanium, but also other metal powders such as but not limited to: magnesium, tantalum, and zirconium. While embodiments of the disclosure are specifically described relative to a reactive metal powder, it will be appreciated that the teachings are also applicable to other non-reactive metal powders.

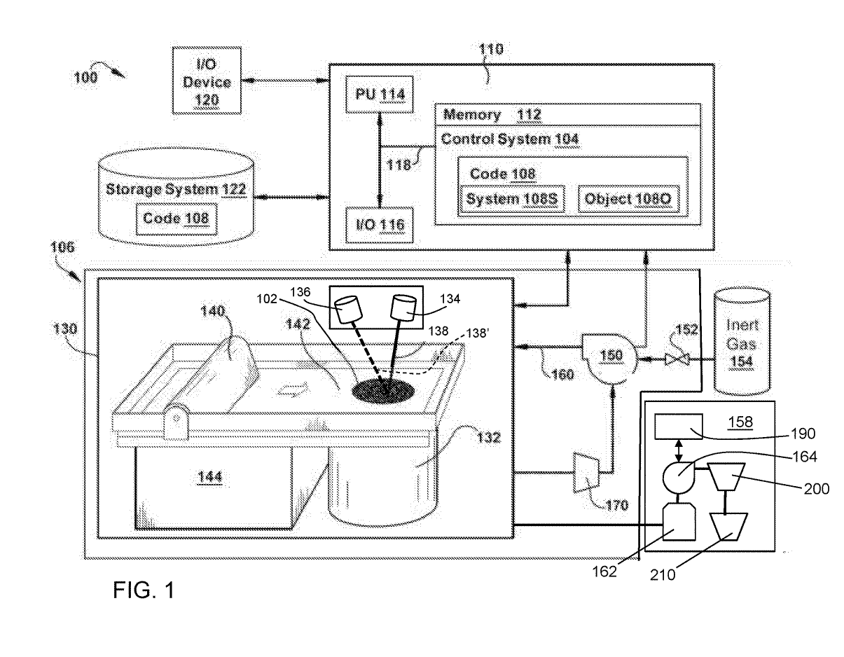

FIG. 1 shows a schematic/block view of an illustrative computerized laser, metal powder additive manufacturing system 100 for generating an object 102, of which only an upper surface is shown. In this example, system 100 is arranged for direct metal laser melting (DMLM). It is understood that the general teachings of the disclosure are equally applicable to other forms of metal powder laser additive manufacturing such as selective laser melting (SLM). Object 102 is illustrated as a circular element; however, it is understood that the additive manufacturing process can be readily adapted to manufacture a large variety of parts.

System 100 generally includes a laser, metal powder additive manufacturing control system 104 (“control system”) and an AM printer 106. As will be described, control system 104 executes code 108 to generate object 102 using multiple lasers 134, 136. Control system 104 is shown implemented on computer 110 as computer program code. To this extent, computer 110 is shown including a memory 112, a processor 114, an input/output (I/O) interface 116, and a bus 118. Further, computer 110 is shown in communication with an external I/O device/resource 120 and a storage system 122. In general, processor 114 executes computer program code 108 that is stored in memory 112 and/or storage system 122. While executing computer program code 108, processor 114 can read and/or write data to/from memory 112, storage system 122, I/O device 120 and/or AM printer 106. Bus 118 provides a communication link between each of the components in computer 110, and I/O device 120 can comprise any device that enables a user to interact with computer 110 (e.g., keyboard, pointing device, display, etc.). Computer 110 is only representative of various possible combinations of hardware and software. For example, processor 114 may comprise a single processing unit, or be distributed across one or more processing units in one or more locations, e.g., on a client and server. Similarly, memory 112 and/or storage system 122 may reside at one or more physical locations. Memory 112 and/or storage system 122 can comprise any combination of various types of non-transitory computer readable storage medium including magnetic media, optical media, random access memory (RAM), read only memory (ROM), etc. Computer 110 can comprise any type of computing device such as an industrial controller, a network server, a desktop computer, a laptop, a handheld device, etc.

As noted, system 100 and in particular control system 104 executes code 108 to generate object 102. Code 108 can include, inter alia, a set of computer-executable instructions 108S for operating AM printer 106, and a set of computer-executable instructions 108O defining object 102 to be physically generated by AM printer 106. As described herein, additive manufacturing processes begin with a non-transitory computer readable storage medium (e.g., memory 112, storage system 122, etc.) storing code 108. Set of computer-executable instructions 108S for operating AM printer 106 may include any now known or later developed software code capable of operating AM printer 106.

Set of computer-executable instructions 108O defining object 102 may include a precisely defined 3D model of an object and can be generated from any of a large variety of well-known computer aided design (CAD) software systems such as AutoCAD®, TurboCAD®, DesignCAD 3D Max, etc. In this regard, code 108O can include any now known or later developed file format. Furthermore, code 108O representative of object 102 may be translated between different formats. For example, code 108O may include Standard Tessellation Language (STL) files which was created for stereolithography CAD programs of 3D Systems, or an additive manufacturing file (AMF), which is an American Society of Mechanical Engineers (ASME) standard that is an extensible markup-language (XML) based format designed to allow any CAD software to describe the shape and composition of any three-dimensional object to be fabricated on any AM printer. Code 108O representative of object 102 may also be converted into a set of data signals and transmitted, received as a set of data signals and converted to code, stored, etc., as necessary. In any event, code 108O may be an input to system 100 and may come from a part designer, an intellectual property (IP) provider, a design company, the operator or owner of system 100, or from other sources. In any event, control system 104 executes code 108S and 108O, dividing object 102 into a series of thin slices that it assembles using AM printer 106 in successive layers of material.

AM printer 106 may include a processing chamber 130 that is sealed to provide a controlled atmosphere for object 102 printing. A metal powder bed or platform 132, upon which object 102 is built, is positioned within processing chamber 130. A number of lasers 134, 136 are configured to melt layers of metal powder on metal powder bed 132 to generate object 102. While a pair of lasers 134, 136 will be described herein, it is emphasized that the teachings of the disclosure are applicable to a system employing a single laser 134 or more than a pair of lasers 134, 136. Each laser 134, 136, as described relative to FIG. 1, has a field in which it can melt metal powder alone and an overlap region in which both lasers 134, 136 can melt metal powder. In this regard, each laser 134, 136 may generate a laser beam 138, 138′, respectively, that fuses particles for each slice, as defined by code 108. Laser 134 is shown creating a layer of object 102 using laser beam 138, while laser 136 is shown dormant but with a phantom laser beam 138′. Each laser 134, 136 is calibrated in any now known or later developed manner. That is, each laser 134, 136 has had its laser beam's anticipated position relative to platform 132 correlated with its actual position in order to provide an individual position correction (not shown) to ensure its individual accuracy.

An applicator 140 may create a thin layer of raw material 142 spread out as the blank canvas from which each successive slice of the final object will be created. Various parts of AM printer 106 may move to accommodate the addition of each new layer, e.g., a metal powder bed 132 may lowered and/or chamber 130 and/or applicator 140 may rise after each layer. The process may use different raw materials in the form of fine-grain metal powder or reactive metal powder, a stock of which may be held in a chamber 144 accessible by applicator 140. In the instant case, object 102 may be made of a “metal” which may include a pure metal or an alloy. The metal may include, for example, any of the aforementioned reactive metals or other metals. System 100 is also capable of use with practically any non-reactive metal powder, i.e., non-explosive or non-conductive powder, such as but not limited to: a cobalt chromium molybdenum (CoCrMo) alloy, stainless steel, an austenite nickel-chromium based alloy such as a nickel-chromium-molybdenum-niobium alloy (NiCrMoNb) (e.g., Inconel 625 or Inconel 718), a nickel-chromium-iron-molybdenum alloy (NiCrFeMo) (e.g., Hastelloy® X available from Haynes International, Inc.), or a nickel-chromium-cobalt-molybdenum alloy (NiCrCoMo) (e.g., Haynes 282 available from Haynes International, Inc.), etc.

Processing chamber 130 is filled with an inert gas such as argon or nitrogen and controlled to minimize or eliminate oxygen to, among other things, prevent a reaction with a reactive metal. Control system 104 is configured to control a flow of a gas mixture 160 within processing chamber 130 from a source of inert gas 154. In this case, control system 104 may control a pump 150, and/or a flow valve system 152 for inert gas to control the content of gas mixture 160. Flow valve system 152 may include one or more computer controllable valves, flow sensors, temperature sensors, pressure sensors, etc., capable of precisely controlling flow of the particular gas. Pump 150 may be provided with our without valve system 152. Where pump 150 is omitted, inert gas may simply enter a conduit or manifold prior to introduction to processing chamber 130. Source of inert gas 154 may take the form of any conventional source for the material contained therein, e.g. a tank, reservoir or other source. Any sensors (not shown) required to measure gas mixture 160 may be provided. Gas mixture 160 may be filtered using a filter 170 in a conventional manner.

In operation, metal powder bed 132 is provided within processing chamber 130, and control system 104 controls flow of gas mixture 160 within processing chamber 130 from source of inert gas 154. Control system 104 also controls AM printer 106, and in particular, applicator 140 and lasers 134, 136 to sequentially melt layers of metal powder on metal powder bed 132 to generate object 102.

After operation of system 100, residual metal powder may remain in processing chamber 130, necessitating cleaning thereof using a reclamation system 158 according to embodiments of the disclosure. Also, metal powder may be loose about system 100, e.g., on a floor, outside of processing chamber 130, etc., necessitating use of reclamation system 158, especially for reactive metal powders. Reclamation system 158 may be incorporated as part of system 100, or may be provided as a separate system used with system 100.

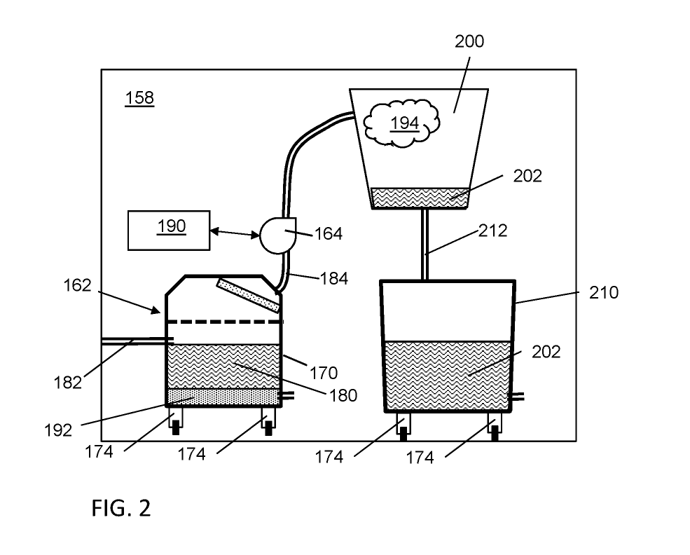

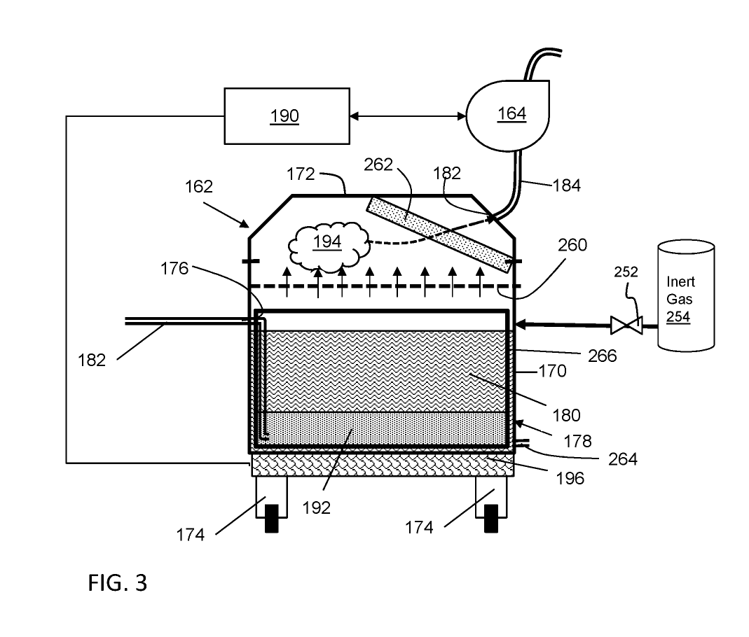

With reference to FIGS. 2 and 3, reclamation system 158 for a metal powder according to embodiments of the disclosure may include a container 162 that is fluidly coupled to a pressure source 164. Container 162 may include any object capable of sealingly containing a liquid material and capable of controlled pressure therein. In one embodiment, container 162 includes a tank 170 having perhaps a removable, but sealable lid 172, and, optionally, caster wheels 174. Container 162 may also include an inlet 176 to a lower portion 178 of the container that is configured to hold a liquid 180. Container 162 also includes an outlet 182. Inlet 176 is fluidly coupled to conduit 184, e.g., tubing, having an outer end (not labeled) that acts as an input for metal powder, similar to an end of a conventional vacuum system. Outer end of tubing 182 may include any now known or later developed vacuum accessory, e.g., wand(s), powered or unpowered brush, crevice tool, bristled dusting brush, upholstery tool, floor brush (with or without twisting stem), etc. Inlet 176 may also include any necessary piping or valving to allow air flow into liquid 180 in lower portion 178, but prevent liquid 180 escaping from container 162 through tubing 182, e.g., a drop tube to a bottom of container 162 or a check valve. Liquid 180 may include water, but also may include other substances conventionally used in immersion separator liquids that may assist in capturing metal powders entering into liquid 180 therein, e.g., oil, detergents, etc.

Pressure source 164 may include any form of vacuum pump, similar to pump 150, capable of creating a selected (air) pressure within container 162, as will be further described herein. Pressure source 164 is in fluid communication with container 162 at outlet 182, e.g., via conduit or tubing 184, which may further extend to a condenser 200, described herein.

Reclamation system 158 may also include a controller 190 for controlling pressure source 164. Controller 190 can include any form of machine controller. In one embodiment, controller 190 can include a simple electronic pressure regulator, but in other embodiments may include a computer controlled pressure regulator. Alternatively, where reclamation system 158 is incorporated as part of additive manufacturing system 100, controller 190 may be incorporated as part control system 104, e.g., part of computer 110. In operation, controller 190 controls pressure source 164 to control, among other things, the pressure applied within container 162. Controller 190 may control pressure source 164 to create a vacuum state in which the pressure creates a flow of air-entrained metal powder to enter inlet 176 (via tubing 182) for forming a reclaimed metal powder 192 (i.e., liquid-metal powder sludge) by removing the metal powder from the air by immersion of the air-entrained metal powder in liquid 180. That is, controller 190 creates a vacuum, negative pressure sufficient to cause vacuuming of metal powder into container 162, through liquid 180, from whatever position the metal powder may be, e.g., within processing chamber 130 (FIG. 1), on a shop floor, etc. In this state, metal powder entrained in an air flow enters inlet 176 and is introduced into liquid 180, in which the metal powder settles out, creating a reclaimed metal powder 192 in the form of a liquid-metal powder sludge. In the vacuum state, reclamation system 158 operates substantially similar to conventional wet or immersion separators.

In contrast to conventional wet or immersion separators, however, as shown in FIG. 3, controller 190 can also control pressure source 164 to create an evaporation state (see upward arrows) in which the pressure within container 164 causes evaporation of liquid 180 to a gas 194 that exits through outlet 182. Controller 190 creates the evaporation state by changing at least one environment characteristic within container 162. In this embodiment, conduit 184 would be removed from a position in which any further metal powder could enter the tubing, and controller 190 may, among other things, modify pressure source 164 to change the pressure in container 162 sufficient to cause evaporation of liquid 180. As liquid 180 evaporates, the level of the liquid lowers in container 162 and the reclaimed metal dries. In one example, controller 190 may reduce the amount of negative pressure such that it is insufficient to further vacuum metal powder into container 162, but is sufficient to cause (or increase) evaporation of liquid 180. In this fashion, liquid 180 in reclaimed metal powder 192 is caused to be removed from the sludge, leaving only drier metal powder in container 162.

In one embodiment, shown in FIG. 3, reclamation system 158 may also include a heating element 196 coupled to container 162 for changing a temperature within the container. Heating element 196 may include any now known or later developed form of heater such as but not limited to an electric heating element, a gas fired heater, an oil-fired heater, etc. Controller 190 may control operation of heating element 196 to change environmental characteristics within container 162 to evaporate liquid 180, e.g., by raising temperature of liquid 180. The temperature increase provided can vary depending on the application, metal powder used, amount of reclaimed metal powder in container 162, amount and constituents of liquid 180 in container 162 and a variety of other factors. While heating element 196 is shown in a bottom of container 162 it can be positioned in any location capable of heating container 162 and/or air entering container 162.

Referring to FIG. 2, reclamation system 158 may also include a condenser 200 in fluid communication with outlet 182 of container 162 for receiving gas 194 from container 162 (via pressure source 164 and conduit 184) and condensing gas 194 to a condensed liquid 202, e.g., water. Condenser 200 may be controlled by controller 190, and may include any now known or later developed commercial condenser. A collection container 210 may be provided for collecting condensed liquid 202 from condenser 200, e.g., through tubing 212. Container 210 may include caster wheels 174, if desired. Condensed liquid 202 may be cleaned in accordance with conventional techniques, and subsequently reused or disposed.

As reclaimed metal 192 dries, at least some of it converts back to powder form, creating a potential risk of ignition or combustion if exposed to an oxygen containing atmosphere. To address this situation, in one embodiment, reclamation system 158 may also include a source of inert gas 254 fluidly coupled to container 162 for injecting an inert gas into the container. The inert gas may include any of the inert gases listed herein for use with AM printer 130, e.g., nitrogen or argon. Here, container 162 can remain in a sealed state, e.g., using valves on inlet 176 and outlet 182, and the inert gas can be provided to container, e.g., via valving 252 and perhaps under control of controller 190, to remove the ignition/combustion risk. Container 162 can remain sealed with inert gas therein until the reclaimed metal powder can be safely disposed or re-used using, e.g., conventional reclamation techniques. In an alternative embodiment, source of inert gas 254 and valve 252 may be the same as source of inert gas 154 and valve 152 coupled to processing chamber 130.

In operation, reclamation system 158, in the vacuum state, entrains the metal powder in an air flow that enters inlet 176 from the vacuum created by pressure source 164. The metal powder is then immersion separated from the air flow by passing the air flow through liquid 180 in container 162, creating reclaimed metal powder 192. The metal powder may then be reclaimed by evaporating liquid 180 from container 162 into gas 194 and removing the gas from the container. As noted above, the reclaiming may include changing at least one environmental characteristic, e.g., pressure and/or temperature, within container 162 from that present during the immersion separating (vacuum state). Gas 194 removed from container 162 may be condensed by condenser 200 to form reclaimed liquid 202, and the reclaimed liquid can be collected in collection container 210. An inert gas may then be introduced (and sealed) in container 162 after the reclaiming for safer handling of the reclaimed metal powder.

Reclamation system 158 may also include a number of alternative structures sometimes provided with wet or immersion separators, but not described herein for brevity. For example, as shown in FIG. 3, container 162 may also include a number of other structures oftentimes found in wet or immersion separators such as: a dispersion plate 260 for dispersing air flow with liquid 180 within container 162, a gas filter or demisting screen 262 (e.g., steel wool screen with retainer) through which gas 194 passes exiting outlet 182, a valved drain 264, closure valves to selectively closing/opening inlet 176 and outlet 182, a liquid height window through a wall of container 162, handles, and a receptacle 266 in container 162 for retaining dried metal powder created by reclamation system 158 and allowing removal thereof from container 162. Reclamation system 158 may also include a pumped filter system (not shown) for liquid 180 and level controls for liquid 180, etc.

The various parts of reclamation system 158 may be made of any material providing sufficient strength and environmental resistance, e.g., metals, hard plastics, etc. While the drawings show a particular layout of the parts of reclamation system 158, it is emphasized that various alternative layouts are possible within the scope of the disclosure.

Reclamation system 158 provides a mechanism that eases hazardous waste disposal relative to metal powders, and especially reactive metal powders, as may be used in additive manufacturing. Reclamation system 158 allows for separation of metal powder and liquid 180 such that both may be reused or more easily disposed, and at the very least more easily handled.

The terminology used herein is for the purpose of describing particular embodiments only and is not intended to be limiting of the disclosure. As used herein, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A reclamation system for a metal powder, the reclamation system comprising:
a container;
a pressure source in fluid communication with the container for creating a selected pressure within the container, the container including: an inlet to a lower portion of the tank that is configured to hold a liquid, and an outlet;
a controller controlling the pressure source to control the pressure applied within the container between: a vacuum state in which the pressure creates a flow of air entrained metal powder to enter the inlet for forming a reclaimed metal powder by removing the metal powder from the air by immersion of the air entrained metal powder in the liquid, and an evaporation state in which the pressure within the container causes evaporation of the liquid to a gas that exits through the outlet; and
a condenser in fluid communication with the outlet of the container for receiving the gas from the container and condensing the gas to a condensed liquid.

2. The reclamation system of claim 1, further comprising a collection container for collecting the condensed liquid from the condenser.

3. The reclamation system of claim 1, wherein the metal powder includes a reactive metal powder selected from the group consisting of aluminum and titanium.

4. The reclamation system of claim 1, wherein the liquid includes water.

5. The reclamation system of claim 1, further comprising a source of inert gas fluidly coupled to the container for injecting an inert gas into the container.

6. The reclamation system of claim 1, further comprising a heating element coupled to the container for changing a temperature within the container.

7. A metal powder additive manufacturing system, comprising:
a metal powder additive manufacturing printer including a processing chamber and a controller; and
a reclamation system for the metal powder, the reclamation system including:
a container;
a pressure source in fluid communication with the container for creating a variable pressure within the container, the container including: an inlet to a lower portion of the tank that is configured to hold a liquid, and an outlet;
a controller controlling the pressure source to control the variable pressure applied within the container between: a vacuum state in which a flow of air entrained metal powder enters the inlet from the processing chamber for forming a reclaimed metal powder by removing the metal powder from the air by immersion of the air entrained metal powder in the liquid, and an evaporation state in which the variable pressure within the container causes evaporation of the liquid to a gas that exits through the outlet; and
a condenser in fluid communication with the outlet of the container for receiving the gas from the container and condensing the gas to a condensed liquid.

8. The metal powder additive manufacturing system of claim 7, wherein the metal powder includes a reactive metal powder selected from the group consisting of aluminum and titanium.

9. The metal powder additive manufacturing system of claim 8, further comprising a source of inert gas fluidly coupled to the container for injecting an inert gas into the container.

10. The metal powder additive manufacturing system of claim 9, wherein the source of inert gas is fluidly coupled to the processing chamber.

11. The metal powder additive manufacturing system of claim 7, wherein the liquid includes water.

12. The metal powder additive manufacturing system of claim 7, wherein the container includes a removable metal powder holder upon which the reclaimed metal powder is collected.

13. The metal powder additive manufacturing system of claim 7, further comprising a heating element coupled to the container for changing a temperature within the container.

14. A method of reclaiming a metal powder, the method comprising:
entraining a metal powder in an air flow;
immersion separating the metal powder from the air flow by passing the air flow through a liquid in a container; and
reclaiming the metal powder by evaporating the liquid from the container into a gas and removing the gas from the container.

15. The method of claim 14, wherein the reclaiming includes changing at least one environmental characteristic within the container from that present during the immersion separating.

16. The method of claim 15, wherein the at least one environmental characteristic includes a pressure within the container.

17. The method of claim 16, wherein the at least one environmental characteristic further includes a temperature within the container.

18. The method of claim 14, further comprising condensing the gas to form a reclaimed liquid, and collecting the reclaimed liquid.

19. The method of claim 14, wherein the metal powder includes a reactive metal powder, and wherein the liquid includes water.

20. The method of claim 19, further comprising introducing an inert gas to the container after the reclaiming.
